(19) United States
(12) Patent Application Publication
(10) Pub. No.: US 2025/0277973 A1
(43) Pub. Date: Sep. 4, 2025

(54) TRANSPORTATION APPARATUS

(71) Applicant: InnoLux Corporation, Miao-Li County (TW)

(72) Inventors: En-Hsiang CHEN, Miao-Li County (TW); Chih-Chin KUO, Miao-Li County (TW); Wenqi LIN, Miao-Li County (TW); Hsu-Kuan HSU, Miao-Li County (TW)

(73) Assignee: InnoLux Corporation, Miao-Li County (TW)

(21) Appl. No.: 19/048,955

(22) Filed: Feb. 9, 2025

(30) Foreign Application Priority Data
Mar. 1, 2024 (CN) 202410231714.7

(51) Int. Cl. G02B 27/01; B60R 11/00; G02B 27/00; G02F 1/1347

(52) U.S. Cl. CPC G02B 27/0101; B60R 11/00; G02B 27/0093; G02B 27/0179; G02F 1/13476; B60R 2011/0026; B60R 2300/205; G02B 2027/0181; G02B 2027/0187

(57) ABSTRACT

Provided is a transportation apparatus including a window, a transparent display device, a lens, and a projection unit. The window has a first region and a second region. The transparent display device is at least partially disposed on the first region, and the lens is disposed on the second region. The projection unit is disposed on a side of the window facing the lens and projects a projection image onto the lens, and the first region does not overlap with the second region.

### BACKGROUND OF THE DISCLOSURE

### 1. Field of the Disclosure

The present disclosure relates to a transportation apparatus and particularly to a transportation apparatus including a transparent display device and a lens.

### 2. Description of the Prior Art

With the development of the technology, traditional dashboard and light signal have been replaced with all sorts of electronic display devices to display information in transportations. In the current transportations, head-up display (HUD) has been developed to project dashboard information onto the windshield, so that a driver may see the dashboard information through the image reflected by the windshield and may simultaneously see objects and scenery outside the transportation. Apart from the dashboard information, the display device may display any suitable image depending on user's requirements, for example, other vehicle information or the combination of displayed image with traffic conditions in the real world, such that driver's awareness to the surroundings may be enhanced to provide a better user experience. Nevertheless, due to the windshield having a certain thickness, the driver may see double image or two image outlines, so that after using for a long period of time, it may easily cause eye fatigue, lowering the quality of user experience or even affecting driving safety.

### SUMMARY OF THE DISCLOSURE

It is an objective of the present disclosure to provide a transportation apparatus to solve the aforementioned problem.

An embodiment of the present disclosure provides a transportation apparatus including a window, a transparent display device, a lens, and a projection unit. The window includes a first region and a second region. The transparent display device is at least partially disposed on the first region, and the lens is disposed on the second region. The projection unit is disposed on a side of the window facing the lens, the projection unit projects a projection image onto the lens, and the first region and the second region are not overlapped with each other.

In the transportation apparatus of the present disclosure, owing to the transparent display device may directly display images or represent image by projection and may not display through window, driver may not see a faint second image, such that safety of the transportation apparatus may be enhanced.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a partial cross-sectional view of a transportation apparatus according to a first embodiment of the present disclosure.

FIG. 2 schematically illustrates a cross-sectional view of a scattering structure according to the first embodiment of the present disclosure.

FIG. 3 and FIG. 4 schematically illustrate a cross-sectional view of a light-adjusting panel in a transparent state and in a dark state according to an embodiment of the present disclosure.

FIG. 5 schematically illustrates a partial cross-sectional view of a transportation apparatus according to a second embodiment of the present disclosure.

FIG. 6 schematically illustrates a front view of a window with a transparent display device and a lens according to the second embodiment of the present disclosure.

FIG. 7 schematically illustrates a cross-sectional view of a transparent display device according to the second embodiment of the present disclosure.

FIG. 8 schematically illustrates a transparent display device according to a first modified embodiment of the second embodiment of the present disclosure.

FIG. 9 schematically illustrates a cross-sectional view of a non-self-emitting display panel according to an embodiment of the present disclosure.

FIG. 10 schematically illustrates a transparent display device according to a second modified embodiment of the second embodiment of the present disclosure.

FIG. 11 schematically illustrates a partial cross-sectional view of a transportation apparatus according to a third embodiment of the present disclosure.

FIG. 12 schematically illustrates a flow chart of an operating method of a transportation apparatus according to an embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function.

In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure.

In addition, when one element or layer is “on” or “above” another element or layer or is “connected to” the another element or layer, it may be understood that the element or layer is directly on the another element or layer or directly connected to the another element or layer, and alternatively, another element or layer may be between the element or layer and the another element or layer (indirectly). On the contrary, when the element or layer is “directly on” the another element or layer or is “directly connected to” the another element or layer, it may be understood that there is no intervening element or layer between the element or layer and the another element or layer.

The term “electrically connected” includes means of direct or indirect electrical connection. Two elements electrically connected to each other may be in direct contact with each other to transfer electrical signals, and there is no other element between them. Alternatively, two elements electrically connected to each other may be bridged through another element between them to transfer electrical signals. The term “electrically connected” may also be referred to as “coupled”.

As disclosed herein, the terms “approximately”, “essentially”, “about”, or “substantially” generally mean within 20%, 10%, 5%, 3%, 2%, 1%, or 0.5% of the reported numerical value or range.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

In the present disclosure, the length, thickness, width, height, distance, and area may be measured by using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

A transportation apparatus of the present disclosure may, for example, be car, airplane, train, or other suitable transportations. A transparent display device may, for example, include a sensing device, an antenna device, a touch device, a tiled device or other suitable display devices, but not limited thereto. The display device of the present disclosure may include liquid crystal, an organic light emitting diode (OLED), an inorganic light emitting diode (LED), a mini light emitting diode (mini LED), a micro light emitting diode (micro LED), a quantum dot (QD), a quantum dot light emitting diode (e. g., QLED or QDLED), electro-phoretic, a fluorescent material, a phosphor material, other suitable materials, or any combination of elements mentioned above, but not limited thereto. The sensing device may, for example, be a sensing device used for detecting variation in capacitances, light, heat, or ultrasound, but not limited thereto. The sensing device may, for example, include a biosensor, a touch sensor, a fingerprint sensor, other suitable sensors, or any combination of sensors mentioned above. The antenna device may, for example, include liquid crystal antenna or antennas of other types, but not limited thereto. The tiled device may, for example, include a tiled display device or a tiled antenna device, but not limited thereto. Furthermore, the appearance of the transparent display device may be, for example, rectangular, circular, polygonal, a shape with curved edges, curved or other suitable shapes. The transparent display device may have peripheral systems such as a driving system, a control system, a light source system, a shelf system, etc. The transparent display device may include electronic units, in which the electronic units may include a passive element and an active element, and for example include a capacitor, a resistor, an inductor, a diode, a transistor, a sensor, etc. It is noted that the electronic device of the present disclosure may be any combination of the above-mentioned devices, but not limited thereto.

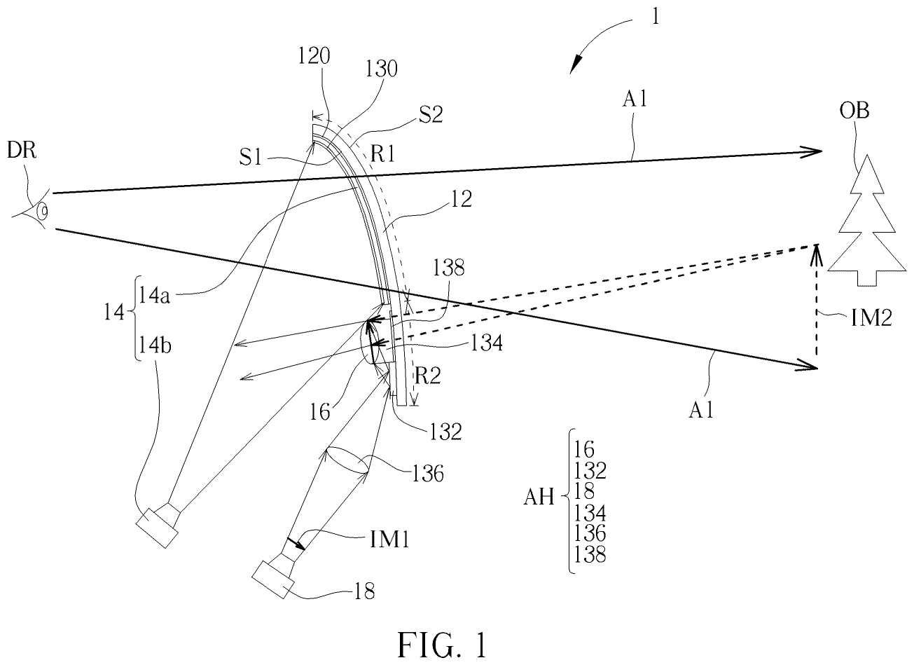

Refer to FIG. 1. FIG. 1 schematically illustrates a partial cross-sectional view of a transportation apparatus according to a first embodiment of the present disclosure. As shown in FIG. 1, a transportation apparatus 1 includes a window 12, a transparent display device 14, a lens 16, and a projection unit 18. The window 12 includes a first region R1 and a second region R2, wherein the first region R1 and the second region R2 are not overlapped with each other. In addition, the transparent display device is at least partially disposed on the first region R1, and the lens 16 is disposed on the second region R2. The projection unit 18 is disposed on a side of the window 12 facing the lens 16 and generates a projection image IM1 projected onto the lens 16. By the imaging of the lens 16, a magnified virtual image IM2 of the projection image IM1 may be displayed on a side of the window 12 away from the lens 16. In this way, a driver DR of the transportation apparatus 1 may simultaneously see the virtual image IM2 and an object OB outside the transportation apparatus 1. It is noted that owing to the transparent display device 14 directly displays the image but not through the window 12, the driver DR may not see a double image, such that safety of the transportation apparatus 1 may be enhanced, and a better user experience may be provided. Besides, by disposing the transparent display device 14 and the lens 16 individually on the first region R1 and the second region R2, which are not overlapped with each other, the interference between the image of the transparent display device 14 and the image of the lens 16 may be reduced, such that the problem of diffraction and/or image distortion may be reduced.

Apart from the above, the transparent display device 14 may allow light to pass through and display images, such that the driver DR may see the image through the transparent display device 14 without affecting safety. The transparent display device 14 may, for example, be used for displaying vehicle information or other suitable images. Taking the transportation apparatus 1 being a car for example, the vehicle information may, for example, include dashboard information or other suitable information. The dashboard information may, for example, include speedometer, fuel gauge, mileage, water temperature, or other suitable information. For the virtual image IM2 is imaged outside the window 12, the content of the projection image IM1 may, for example, be a pattern combine with the object OB in order to form the virtual image of the augmented reality (AR), such that interactive information with the object OB may be presented. In other words, the virtual image IM2 may be further away from the driver DR than the image displayed by the transparent display device 14, so the driver DR may simultaneously see the image displayed by the transparent display device 14 closer to the driver DR and the virtual image IM2 further away from the driver DR without adjusting viewing angle. In some embodiments, the image of the transparent display device 14 may or may not be overlapped with the virtual image IM2.

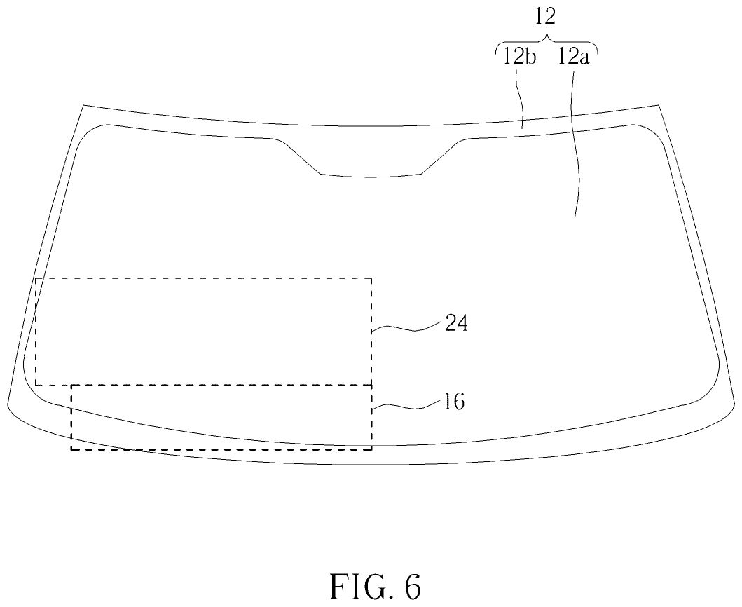

The window 12 may, for example, be the window in front of the driver DR in the transportation apparatus 1, wherein the window 12 viewed by the driver DR may, for example, be shown in following FIG. 6, but not limited thereto. The shape of the window 12 may be adjusted according to different transportation apparatus 1 or different design requirements. The window 12 may include transparent windshield, which, for example, includes tempered glass, laminated glass, acrylic, or other suitable materials. The window 12 may include an inner surface S1 facing the driver DR and an outer surface S2 facing the object OB, and the transparent display device 14 and the lens 16 may be disposed on the inner surface S1.

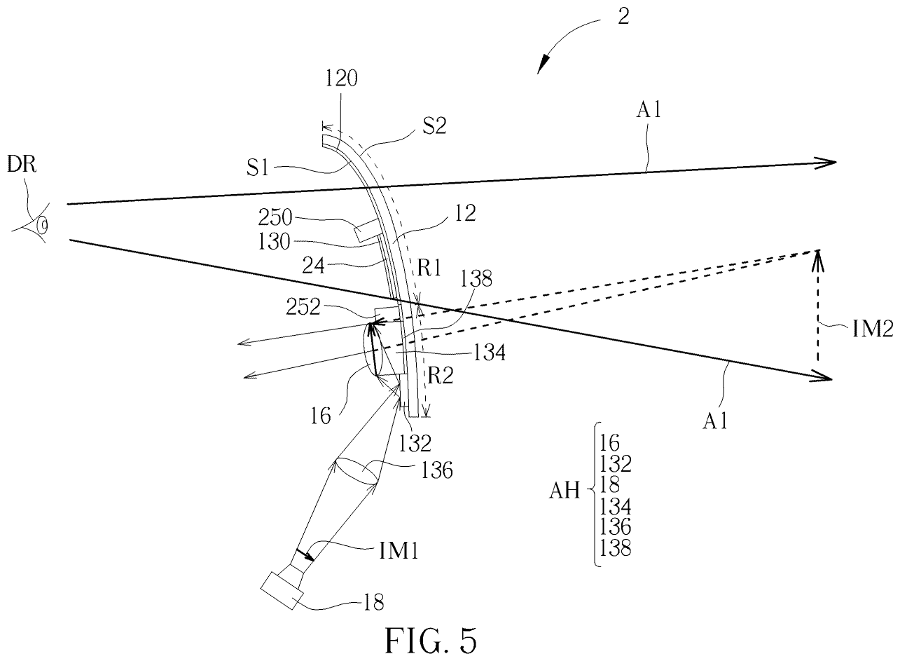

In FIG. 1, the first region R1 and the second region R2 of the window 12 may be different portions of the windshield, which are not overlapped with each other. For example, the first region R1 may be located on the second region R2. That is, the first region R1 may be closer to the range of viewing angle of the driver DR in operation compared with the second region R2, such as a region between two arrows A1 in FIG. 1. In the embodiment of FIG. 1, the first region R1 may, for example, be the region of the window 12 except for the second region R2, but not limited thereto. In other embodiments, the first region R1 may, for example, be the region of the window 12 at least overlapped with a scattering structure 14a in FIG. 1 and/or a transparent display device 24 in FIG. 5, while the rest of the region of the window 12 may be the second region R2. Or, the first region R1 may, for example, be the region of the window 12 overlapped with the light-adjusting panel 120 in FIG. 1 and FIG. 5, and the rest of the region of the window 12 may be the second region R2, but the present disclosure is not limited thereto.

In the embodiment of FIG. 1, the transparent display device 14 may include a scattering structure 14a. Specifically, the scattering structure 14a is disposed on the inner surface S1 of the first region R1 of the window 12, and the transparent display device 14 may further include another projection unit 14b disposed on a side of the scattering structure 14a opposite to the window 12. The projection unit 14b projects another projection image onto the scattering structure 14a in order to display images on the scattering structure 14a. The projection unit 14b may, for example, be image projection element or other elements capable of projecting images. It is noted that the projection unit 14b may be disposed outside the range of viewing angle of the driver DR to avoid affecting safety of the transportation apparatus 1 in operation. The projection unit 14b may, for example, be disposed under or above the range of viewing angle and between the driver DR and the window 12 or other suitable positions. In addition, in order to allow the driver DR to see the outside object OB and simultaneously see the virtual image IM2 through the scattering structure 14a, the haze of the scattering structure 14a may be in the range of 5% to 15% or 8% to 10%.

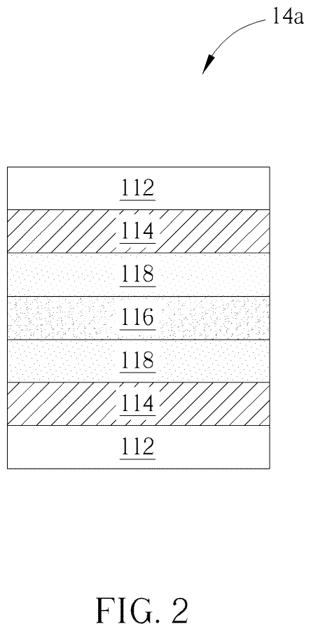

Refer to FIG. 2. FIG. 2 schematically illustrates a cross-sectional view of a scattering structure according to the first embodiment of the present disclosure. As shown in FIG. 2, the scattering structure 14a may include two substrates 112, two transparent electrode layers 114, and a liquid crystal layer 116, wherein the substrates 112 may be disposed opposite to each other and may be sequentially disposed on the inner surface S1 of the window 12, the liquid crystal layer 116 is disposed between the substrates 112, and the transparent electrode layers 114 may respectively be disposed between the corresponding substrates 112 and the liquid crystal layer 116, such that the liquid crystal layer 116 is disposed between the transparent electrode layers 114. By controlling the voltage difference between the transparent electrode layers 114, a light transmittance of the liquid crystal layer 116 may be adjusted, such that the haze of the scattering structure 14a may be adjusted. The liquid crystal layer 116 may, for example, include polymer network liquid crystal (PNLC), polymer dispersed liquid crystal (PDLC), or other suitable materials capable of switching between transparent state and haze state. The transparent electrode layer 114 may, for example, include indium tin oxide (ITO) or other suitable transparent conductive materials. The substrate 112 may, for example, include flexible substrate, such that the scattering structure 14a may be attached to or conformed with the first region R1 of the window 12. The flexible substrate may, for example, include polyethylene terephthalate (PET), polyimide (PI), polycarbonate (PC), poly (methyl methacrylate) (PMMA), or other suitable substrate materials.

In the embodiment of FIG. 2, the scattering structure 14a may cover the entire first region R1, for example, an edge of the scattering structure 14a may be extended to be adjacent to or be aligned to an edge of the window 12 away from the lens 16. Under this circumstance, the transparent electrode layer 114 may not be patterned and cover the entire first region R1, such that the scattering structure 14a may present uniform haze, but not limited thereto. In some embodiments, the scattering structure 14a may not cover the first region R1 and may be disposed in the range of viewing angle of the driver DR.

In the embodiment of FIG. 2, the scattering structure 14a may optionally further include two alignment layers 118 respectively disposed between the corresponding transparent electrode layers 114 and the liquid crystal layer 116, such that liquid crystal molecules in the liquid crystal layer 116 may be pre-aligned to a predetermined direction, but not limited thereto. The alignment layer 118 may, for example, include PI or other suitable materials. In some embodiments, the scattering structure 14a may not include the alignment layer 118.

As shown in FIG. 1, the transportation apparatus 1 may optionally further include a light-adjusting panel 120 disposed between the scattering structure 14a and the window 12. In an embodiment, an area of the light-adjusting panel 120 may be substantially identical to an area of the scattering structure 14a of the transparent display device 14, such as covering the first region R1, but not limited thereto. In some embodiments, the light-adjusting panel 120 may cover the entire inner surface S1 of the window 12 in order to adjust the brightness of ambient light entering the transportation apparatus 1 after passing through the window 12, such that the light-adjusting panel 120 may include thermal insulation function and may replace traditional thermal insulation film, but not limited thereto.

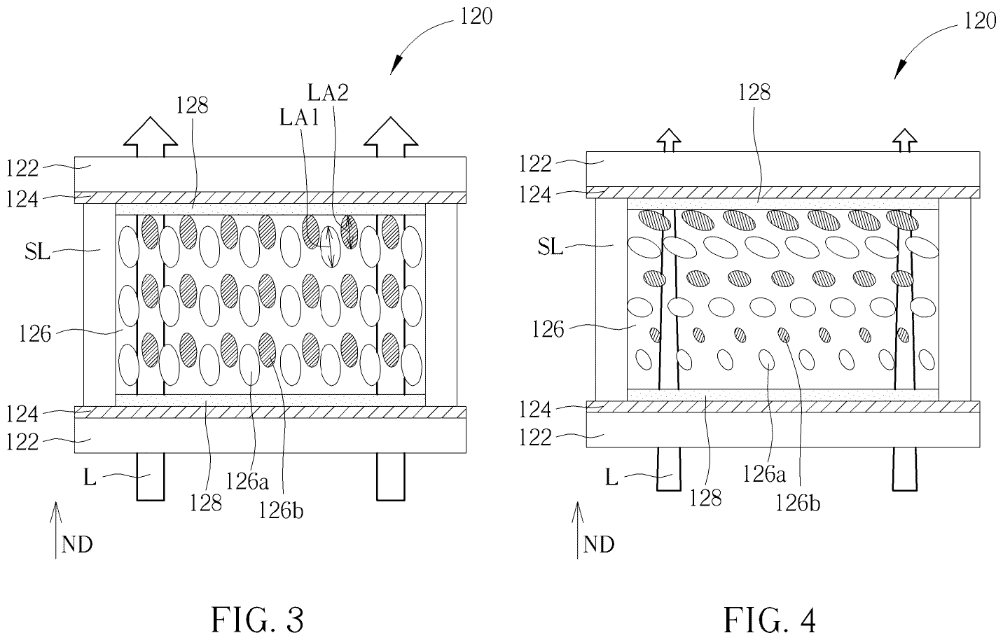

Refer to FIG. 3 and FIG. 4. FIG. 3 and FIG. 4 schematically illustrate a cross-sectional view of a light-adjusting panel in a transparent state and in a dark state according to an embodiment of the present disclosure. As shown in FIG. 3 and FIG. 4, the light-adjusting panel 120 may include two substrates 122, two transparent electrode layers 124, and a liquid crystal layer 126, wherein the substrates 122 may be disposed opposite to each other and may be sequentially disposed on the window 12, the liquid crystal layer 126 is disposed between the substrates 122, and each of the transparent electrode layers 124 may be disposed between the corresponding substrate 122 and the liquid crystal layer 126, such that the liquid crystal layer 126 is sandwiched between the transparent electrode layers 124. The substrate 122 may, for example, be identical or similar to the aforementioned substrate 112, and the transparent electrode layer 124 may, for example, be identical or similar to the above-mentioned transparent electrode layer 114, so that they are not repeated herein.

In this embodiment, the liquid crystal layer 126 may include dye liquid crystal, but not limited thereto. For example, the liquid crystal layer 126 may include liquid crystal molecules 126a and dye molecules 126b, and the dye molecules 126b are mixed in the liquid crystal molecules 126a, such that the intermolecular force acts between the dye molecule 126b and the liquid crystal molecule 126a. Hence, the direction of the dye molecule 126b may alter according to the adjustment of the direction of the liquid crystal molecule 126a. Specifically, each of the liquid crystal molecules 126a may include a long axis LA1, each of the dye molecules 126b may include a long axis LA2, and the long axis LA1 of the liquid crystal molecule 126a may be substantially parallel to the long axis LA2 of the dye molecule 126b. As shown in FIG. 3, when the voltage difference between the transparent electrode layers 124 is not yet provided, the direction of the long axis LA1 of the liquid crystal molecule 126a may substantially be parallel to a normal direction ND of the substrate 122 (or parallel to incident direction of the light L), such that the direction of the long axis LA2 of the dye molecule 126b may be substantially parallel to the normal direction ND of the substrate 122. Therefore, the light L may pass through the liquid crystal layer 126, and the light-adjusting panel 120 may be in a transparent state. Under this condition, an angle between the direction of the long axis LA1 of each liquid crystal molecule 126a and the normal direction ND of the substrate 122 may be substantially be 1 to 3 degrees. As the light-adjusting panel 120 is attached to the inner surface S1 of the window 12 in FIG. 1, the normal direction ND of the substrate 122 may vary with the curvature of the inner surface S1. The normal direction ND of the substrate 122 may, for example, be perpendicular to the tangent surface of the inner surface S1, that is, be parallel to the normal direction of the inner surface S1. As shown in FIG. 4, by providing the voltage difference between the transparent electrode layers 124, the long axis LA1 of the liquid crystal molecule 126a may be driven to rotate, such that the long axis LA2 of the dye molecule 126b may rotate as well to be substantially perpendicular to the normal direction ND of the substrate 122. When the direction of the long axis LA2 of the dye molecule 126b is substantially perpendicular to the normal direction ND of the substrate 122, the light L may be absorbed by the dye molecule 126b. Accordingly, the light-adjusting panel 120 may block the light L from passing through, and the light-adjusting panel 120 is in a dark state. It is noted that owing to the light-adjusting panel 120 is in the transparent state as there is no voltage difference between the transparent electrode layers 124, energy consumption of the light-adjusting panel 120 may be reduced, and safety of the driver may be enhanced as the transportation apparatus 1 loses power. In some embodiments, the light-adjusting panel 120 may alternatively be in the dark state as there is no voltage difference between the transparent electrode layers 124 and may be in the transparent state as there is the voltage difference between the transparent electrode layers 124.

In the embodiment of FIG. 3 and FIG. 4, the light-adjusting panel 120 may optionally further include two alignment layers 128 respectively disposed between the corresponding transparent electrode layers 124 and the liquid crystal layer 126, such that the liquid crystal molecules in the liquid crystal layer 126 may be pre-aligned to a predetermined direction. For example, the alignment layers 128 may let the liquid crystal molecules 126a have a predetermined inclined angle, such that the direction of the long axis LA1 of the liquid crystal layer 126a may be substantially parallel to the normal direction ND of the substrate 122 as no voltage difference is provided between the transparent electrode layers 124, but not limited thereto. The alignment layers 128 may, for example, be identical or similar to the aforementioned alignment layers 118, so they are not detailed redundantly herein. In some embodiments, the light-adjusting panel 120 may not include the alignment layers 128.

As shown in FIG. 3 and FIG. 4, the light-adjusting panel 120 may further include a sealant SL disposed between the substrates 122 and surrounding the liquid crystal layer 126. The sealant SL may be used for attaching the substrates 122 to each other and encapsulating the liquid crystal layer 126 between the substrates 122. The sealant SL may, for example, include adhesive materials or other suitable materials.

In the embodiment of FIG. 1, the transportation apparatus 1 may optionally further include another light-adjusting panel 130 disposed on a side of the scattering structure 14a of the transparent display device 14 opposite to the window 12; that is, the scattering structure 14a of the transparent display device 14 may be disposed between the window 12 and the light-adjusting panel 130. In an embodiment, the structure of the light-adjusting panel 130 may be identical or similar to the light-adjusting panel 120, such that the transparent state or the dark state of the light-adjusting panel 130 may be switched by controlling the voltage difference between the transparent electrode layers 124. Hence, it may refer to the above-mentioned contents, and here will be no further elaborations. As the brightness in the transportation apparatus 1 is brighter, by adjusting the light transmittance of the light-adjusting panel 130, the light-adjusting panel 130 may be used for absorbing at least a portion of stray light in the transportation apparatus 1, such that the contrast ratio of the image displayed by the transparent display device 14 may be enhanced. As the brightness in the transportation apparatus 1 is dimmer, the light-adjusting panel 130 may be in the transparent state, but not limited thereto. The area of the light-adjusting panel 130 may be identical or similar to the area of the scattering structure 14a of the transparent display device 14, but not limited thereto. In some embodiments, the transportation apparatus 1 may alternatively not include the light-adjusting panel 130.

As shown in FIG. 1, the lens 16 may, for example, be a convex lens or other suitable types of lens. The projection unit 18 may, for example, be an image projection element or other elements capable of projecting images. In the embodiment of FIG. 1, the transportation apparatus 1 may further includes a reflective mirror 132 disposed on the side of the window 12 facing the lens 16, that is, on the inner surface S1 of the second region R2, wherein the projection image IM1 generated by the projection unit 18 may be projected onto the lens 16 through the reflective mirror 132, such that the virtual image IM2 is displayed outside the window 12. For example, the position of the reflective mirror 132 projected on a light axis of the lens 16 along a direction perpendicular to the light axis of the lens 16 may be between the lens 16 and a focal point of the lens, but not limited thereto. That is, the lens 16, the reflective mirror 132, and the projection unit 18 may form an AR head up display (HUD) system AH, but not limited thereto.

In the embodiment of FIG. 1, the AR HUD system AH may further include a spacer 134 disposed between the lens 16 and the window 12 to control a distance between the lens 16 and the reflective mirror 132. In order to allow the image reflected by the reflective mirror 132 to form the virtual image IM2 through the lens 16, a thickness of the spacer 134 may be less than a focal distance of the lens 16, but not limited thereto. In an embodiment, the spacer 134 may be attached to the window 12 by an adhesive layer, and the lens 16 may be attached to the spacer 134, but not limited thereto. The spacer 134 may, for example, include PMMA, cyclo-olefin polymers (COP), PET, or other suitable flexible substrate materials.

In the embodiment of FIG. 1, the AR HUD system AH of the transportation apparatus 1 may optionally further include another lens 136 disposed between the projection unit 18 and the reflective mirror 132 to focus the projection image IM1 of the projection unit 18 onto the reflective mirror 132, but not limited thereto. By adjusting the position of the lens 136, the distance between the virtual image IM2 and the lens 16 may be altered. The lens 136 may, for example, be a convex lens or other suitable types of optical elements.

It is noted that the lens 16, the reflective mirror 132, the lens 136, and the projection unit 18 may be disposed outside the range of viewing angle of the driver DR to avoid affecting safety of the transportation apparatus 1 in operation, for example, may be disposed under the range of viewing angle and between the driver DR and the window 12 or other suitable positions. In the application of car, the lens 136 and the projection unit 18 may be embedded into the dashboard, but not limited thereto.

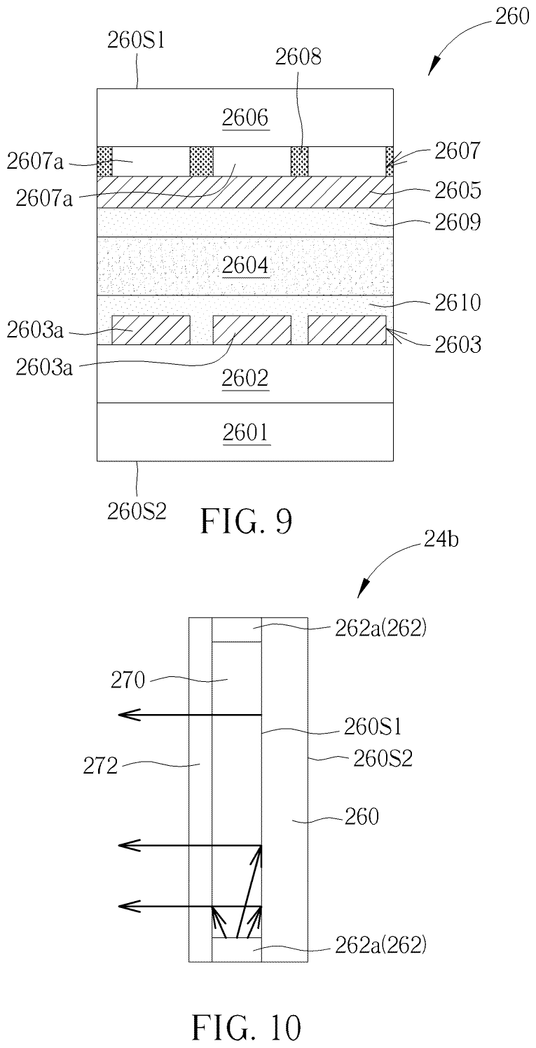

In the embodiment of FIG. 1, the AR HUD system AH of the transportation apparatus 1 may further include another light-adjusting panel 138 disposed between the lens 136 and the window 12 to dynamically adjust the contrast ratio of the virtual image IM2. In some embodiments, the light-adjusting panel 138 may alternatively be a structure that pixelates the light-adjusting panel 120 in FIG. 3. For example, the light-adjusting panel 138 may include a circuit layer disposed between one of the transparent electrode layers 124 and the substrate 122, and the one of the transparent electrode layers 124 may include a plurality of pixel electrodes. In this case, the light transmittances of different regions of the light-adjusting panel 138 may be adjusted dynamically according to requirements to reduce effect of light with a certain noise outside the transportation apparatus 1 on the virtual image IM2 or to enhance the contrast ratio of the virtual image IM2. Besides, as the brightness of the virtual image IM2 is too low, the brightness of the virtual image IM2 may be enhanced through the intensity of the projection image IM1 of the projection unit 18. The pixel electrodes of the light-adjusting panel 138 in this case may, for example, have the same structure as the pixel electrodes 2603a shown in FIG. 9, but not limited thereto. In some embodiments, the resolution of the light-adjusting panel 138 may be identical to or different from the resolution of the projection unit 18. In some embodiments, the combination of the light-adjusting panel 138 and the light-adjusting panel 120 may cover the entire inner surface S1 of the window 12 to be used as thermal insulation film, but not limited thereto. For example, the light-adjusting panel 138 and the light-adjusting panel 120 may be tiled together to be the same panel, such that gap between them may not be obvious, enhancing visual experience in whole. The term “dynamically adjust” in the present disclosure may, for example, refer to separately adjusting transmittances in different regions, but not limited thereto.

The transportation apparatus of the present disclosure is not limited to the above-mentioned embodiments and may have other embodiments or other modified embodiments. To simplify description, other embodiments and other modified embodiments in the following contents will use the same notations to the same elements from the above mentioned embodiments. To clearly clarify other embodiments and other modified embodiments, the following contents will emphasize on the differences between other embodiments and the above mentioned embodiment and between other modified embodiments and the above mentioned embodiment, and will not further elaborate for the repeated part.

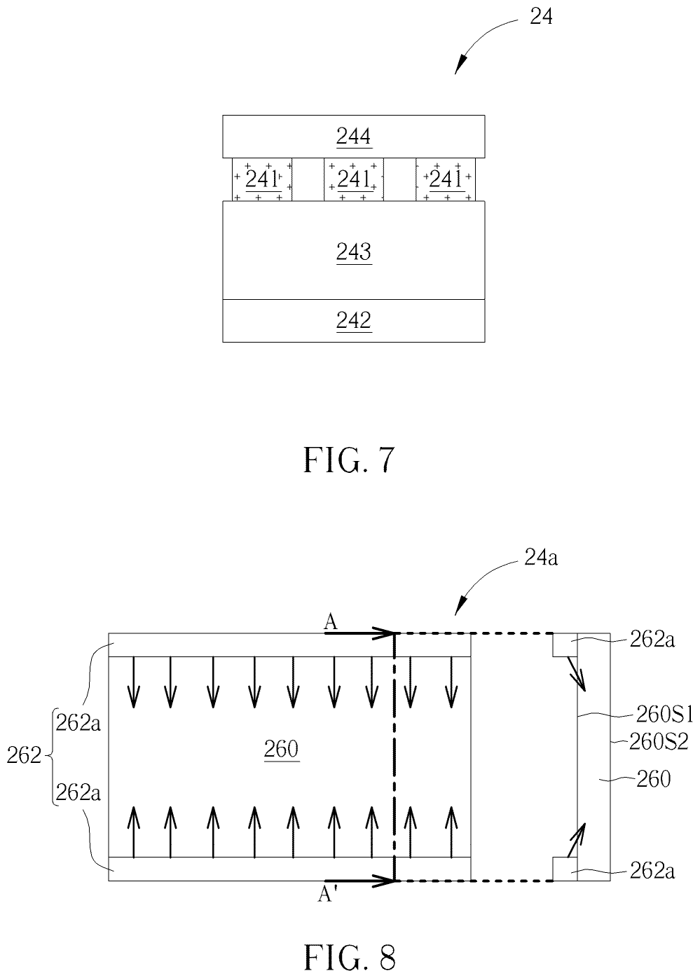

Refer to FIG. 5 to FIG. 7. FIG. 5 schematically illustrates a partial cross-sectional view of a transportation apparatus according to a second embodiment of the present disclosure. FIG. 6 schematically illustrates a front view of a window with a transparent display device and a lens according to the second embodiment of the present disclosure. FIG. 7 schematically illustrates a cross-sectional view of a transparent display device according to the second embodiment of the present disclosure. As shown in FIG. 5, a difference between the transportation apparatus 2 of this embodiment and the transportation apparatus 1 in FIG. 1 is that the transparent display device 24 of this embodiment may be a self-emitting transparent display device. In the embodiment of FIG. 5, the transparent display device 24 may not include the projection unit 14b, and the transparent display device 24 may not cover the entire first region R1. The light-adjusting panel 120 may be disposed between the transparent display device 24 and the window 12, and the transparent display device 24 may be disposed between the light-adjusting panel 120 and the light-adjusting panel 130, but not limited thereto. It is noted that the transparent display device 24 may directly display images and may not present through the window 12. Hence, the driver DR may not see the double image, so as to enhance safety of the transportation apparatus 2 and provide a better user experience.

In the embodiment of FIG. 5, the area of the light-adjusting panel 130 may be identical or similar to the area of the transparent display device 24 and may be partially be overlapped with the first region R1, but not limited thereto. In some embodiments, the transportation apparatus 2 may alternatively not include the light-adjusting panel 130.

As shown in FIG. 6, the transparent display device 24 may be disposed on the lens 16, and both the transparent display device 24 and the lens 16 may not be overlapped with each other in the normal direction of the inner surface S1 of the window 12. As the inner surface S1 is a curved surface, the normal direction of the inner surface S1 may vary depending on different positions on the inner surface S1 and may be perpendicular to any tangent surface of any point on the inner surface S1. In some embodiments, the window 12 in FIG. 6 may be applied to the transportation apparatus according to any aforementioned or following embodiments. In some embodiments, the window 12 may further include a transparent part 12a and a light shielding part 12b, wherein the light shielding part 12b surrounds the transparent part 12a, but not limited thereto. The transparent display device 24 and the lens 16 may be disposed corresponding to the transparent part 12a.

As shown in FIG. 7, the transparent display device 24 may include a plurality of self-emitting units 241 to generate light. For example, the transparent display device 24 may further include a substrate 242 and a circuit layer 243, wherein the circuit layer 243 is disposed on the substrate 242, and the self-emitting units 241 may be disposed on the circuit layer 243. Each of the self-emitting units 241 may be controlled by the circuit layer 243 to generate light with required brightness, such that the transparent display device 24 may display vehicle information. The self-emitting unit 241 may, for example, include a light emitting diode. The light emitting diode may, for example, include an organic light emitting diode (OLED), a mini light emitting diode (mini LED), a micro light emitting diode (micro LED), a quantum dot light emitting diode (e.g., QLED or QDLED), other suitable materials, or any combination of the aforementioned materials, but not limited thereto. In some embodiments, the self-emitting units 241 may, for example, generates identical or different colors of light, such as red, green, and blue. The self-emitting units 241 may, for example, be used as sub-pixels displaying different colors of light, but not limited thereto. The circuit layer 243 may, for example, include signal lines, insulation layers, active elements, and/or passive elements. The active element may, for example, include a thin film transistor or other suitable transistors, but not limited thereto. The signal lines may, for example, include data lines, scan lines, common lines, or other required signal lines. In some embodiments, the transparent display device 24 may optionally further include another substrate 244 or a protection layer disposed on the self-emitting units 241 to protect the self-emitting units 241. The substrate 242 and the substrate 244 may, for example, be similar or identical to the above-mentioned substrate 112, and here will be no further elaboration.

In the embodiment of FIG. 5, the transportation apparatus 2 may optionally further include an eye tracking sensor 250 disposed on a side of the transparent display device 24. The eye tracking sensor 250 may, for example, be electrically connected to the transparent display device 24. The gaze point of eyes or the motion of the eyes relative to the head of the driver DR may be detected by the eye tracking sensor 250 to identify the position of viewing angle of the driver DR, such that the transparent display device 24 may display images in the range of viewing angle. Hence, the driver DR may not need to move or lower his/her head and may not be distracted to see the images, which enhances the safety of the transportation apparatus 2. In some embodiments, the eye tracking sensor 250 in FIG. 5 may be applied to the transportation apparatus 1 in FIG. 1 and may be disposed on a side of the scattering structure 14a or may be applied to the transportation apparatus according to any one of the following embodiments. In some embodiments, the eye tracking sensor 250 may be alternatively disposed on a side of the lens 16 or the spacer 134, but not limited thereto. In some embodiments, the transportation apparatus 2 may not include the eye tracking sensor 250.

In the embodiment of FIG. 5, the transportation apparatus 2 may optionally further include a voice-activated device 252 disposed on a side of the lens 16 or the spacer 134 or a side of the transparent display device 24. The voice-activated device 252 may, for example, include a voice recognition system. Instructions of the driver DR may be received by the voice-activated device 252 to selectively display corresponding information on the transparent display device 24 and/or display corresponding interactive information through the projection unit 18. For example, as the transportation apparatus 2 is a car and the navigation is on, the virtual image IM2 formed by the projection unit 18 may include navigation information matching real road, but not limited thereto. In some embodiments, the voice-activated device 252 in FIG. 5 may be applied to the transportation apparatus according to any aforementioned or following embodiments. In some embodiments, the voice-activated device 252 may be replaced with a touch device, but not limited thereto. In some embodiments, the transportation apparatus 2 may not include the voice-activated device 252.

Refer to FIG. 8 and FIG. 9. FIG. 8 schematically illustrates a transparent display device according to a first modified embodiment of the second embodiment of the present disclosure, and FIG. 9 schematically illustrates a cross-sectional view of a non-self-emitting display panel according to an embodiment of the present disclosure, wherein a left part of FIG. 8 is a top view of the transparent display device, and a right part of FIG. 8 is a cross-sectional view taken along a line A-A′ in the left part. As shown in FIG. 8, a difference between the transparent display device 24a of this modified embodiment and the transparent display device 24 in FIG. 7 is that the transparent display device 24a may include a non-self-emitting display panel 260 and a front light source 262, and the front light source 262 may be disposed on a side of the non-self-emitting display panel 260 opposite to the window 12 in FIG. 5. To be specific, the non-self-emitting display panel 260 may include a front surface 260S1 and a rear surface 260S2 opposite to the front surface 260S1, wherein the front surface 260S1 may face the driver DR in FIG. 5 and may display images, and the rear surface 260S2 may face the window 12 in FIG. 5, but not limited thereto. The front light source 262 may be disposed on the front surface 260S1 and may be adjacent to an edge of the non-self-emitting display panel 260. In the embodiment of FIG. 8, the front light source 262 may include two light bars 262a respectively disposed adjacent to two opposite edges of the non-self-emitting display panel 260, such that the light bars 262a may emit light toward the part of the non-self-emitting display panel 260 displaying images. For example, as the ambient light outside the transportation apparatus is too dim, for example, at night, the front light source 262 may shine light on images displayed by the non-self-emitting display panel 260 to help the driver DR to see the images clearly. In some embodiments, the transportation apparatus may further include an ambient light sensor to detect the brightness of the ambient light, such that control unit of the transportation apparatus may determine whether turning on or off the front light source 262 of the transparent display device 24a. The front light source 262 of the present disclosure is not limited to that shown in FIG. 8. In some embodiments, the front light source 262 may be other types or other structure of light source.

As shown in FIG. 9, the non-self-emitting display panel 260 may, for example, be a structure that pixelates the scattering structure 14a in FIG. 2. Specifically, the non-self-emitting display panel 260 may include a substrate 2601, a circuit layer 2602, a transparent electrode layer 2603, a liquid crystal layer 2604, a common electrode layer 2605, and a substrate 2606. The substrate 2601 and the substrate 2606 may be disposed opposite to each other, and the liquid crystal layer 2604 is disposed between the substrate 2601 and the substrate 2606. The substrate 2601 and the substrate 2606 may, for example, be similar or identical to the aforementioned substrate 112, and the liquid crystal layer 2604 may, for example, be similar or identical to the aforementioned liquid crystal layer 116, so that here will be no further elaborations. A surface of the substrate 2606 away from the substrate 2601 and a surface of the substrate 2601 away from the substrate 2606 may, for example, respectively be the front surface 260S1 and the rear surface 260S2, but not limited thereto. The circuit layer 2602 may be disposed between the substrate 2601 and the liquid crystal layer 2604, and the transparent electrode layer 2603 may be disposed between the circuit layer 2602 and the liquid crystal layer 2604. And, the voltage of the transparent electrode layer 2603 may be controlled by the circuit layer 2602. The transparent electrode layer 2603 may include a plurality of pixel electrodes 2603a respectively corresponding to pixels or sub-pixels of the non-self-emitting display panel 260, and each of the pixel electrodes 2603a may be used for controlling the haze of the part of the liquid crystal layer 2604 in the corresponding pixel or the sub-pixel. The common electrode layer 2605 may be disposed between the substrate 2606 and the liquid crystal layer 2604. The common electrode layer 2605 and the transparent electrode layer 2603 may, for example, include identical or similar transparent conductive materials of the aforementioned transparent electrode layer 114, so they are not repeated herein. It is noted that owing to the circuit layer 2602 may separately provide voltages to the pixels electrodes 2603a to control the voltage differences between the pixel electrodes 2603a and the common electrode layer 2605, the parts of the liquid crystal layer 2604 of different pixels may present haze state. In this way, the non-self-emitting display panel 260 may display a haze state pattern to present vehicle information.

In the embodiment of FIG. 9, the non-self-emitting display panel 260 may further include a color filter layer 2607 and a black matrix 2608 disposed between the substrate 2606 and the common electrode layer 2605. The color filter layer 2607 may include a plurality of color filters 2607a respectively having different colors, such as red, green, blue, or other suitable colors. Each of the color filters 2607a may respectively be disposed corresponding to one of the pixel electrodes 2603a. The black matrix 2608 may be disposed between the color filters 2607a to shield metal wires in the circuit layer 2602. The black matrix 2608 may further include an opening without disposing the color filter layer 2607, such that the non-self-emitting display panel 260 may allow light to pass through and may be a transparent display panel. In some embodiments, the non-self-emitting display panel 260 may not include the black matrix 2608. Under this condition, a surface of a metal layer of the circuit layer 2602 may form an anti-reflection layer or a low-reflection layer to reduce the visibility of the circuit layer 2602. In some embodiments, the non-self-emitting display panel 260 may not display color images and may not include the color filter layer 2607, but not limited thereto.

In FIG. 9, the non-self-emitting display panel 260 may optionally further include an alignment layer 2609 and an alignment layer 2610 respectively disposed between the transparent electrode layer 2603 and the liquid crystal layer 2604 and between the common electrode layer 2605 and the liquid crystal layer 2604, but not limited thereto.

Refer to FIG. 10. FIG. 10 schematically illustrates a transparent display device according to a second modified embodiment of the second embodiment of the present disclosure. As shown in FIG. 10, a difference between the transparent display device 24b of this modified embodiment and the transparent display device 24a in FIG. 8 is that the transparent display device 24b may further include a light guide plate 270 and a protection layer 272. The light guide plate 270 may be disposed on the front surface 260S1 of the non-self-emitting display panel 260 and may be used to uniformly emit light from the light bars 262a to the non-self-emitting display panel 260, such that the transparent display device 24b may display the image with even brightness. The protection layer 272 is disposed on a surface of the light guide plate 270 away from the non-self-emitting display panel 260 to protect the light guide plate 270 and the front light source 262. The protection layer 272 may include transparent insulation materials to allow light to pass through.

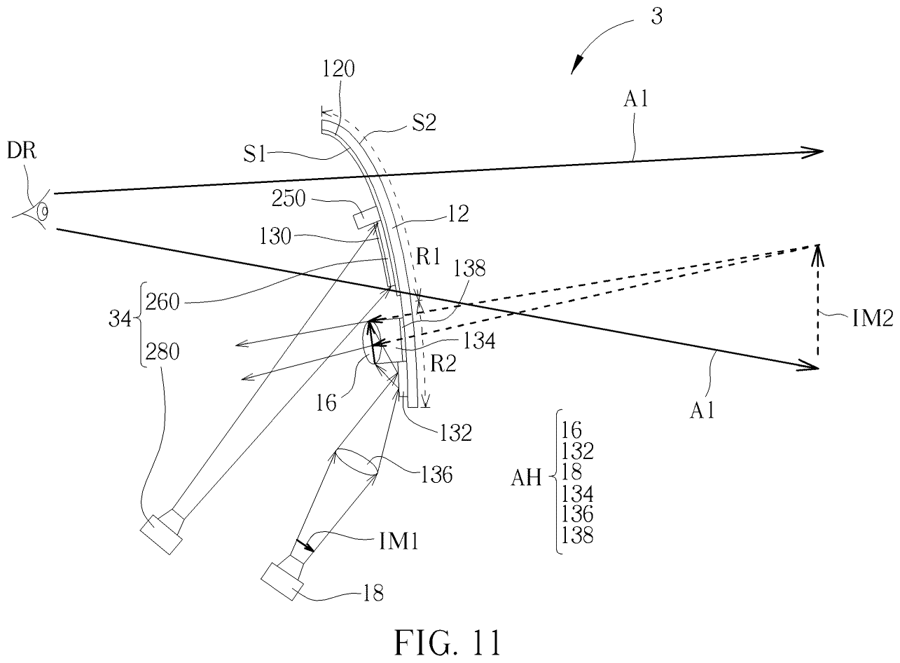

Refer to FIG. 11. FIG. 11 schematically illustrates a partial cross-sectional view of a transportation apparatus according to a third embodiment of the present disclosure. As shown in FIG. 11, a difference between the transportation apparatus 3 of this embodiment and the transportation apparatus 2 in FIG. 5 is that the transparent display device this 34 of embodiment may include the non-self-emitting display panel 260 and a projection light source 280. The non-self-emitting display panel 260 of this embodiment may, for example, be similar or identical to the non-self-emitting display panel 260 in FIG. 9, so it is not detailed redundantly. The projection light source 280 may be disposed outside the range of viewing angle, which is the region between the arrows A1 in FIG. 11, of the driver DR to avoid affecting safety of the transportation apparatus 3 in operation. The projection light source 280 may, for example, be disposed under or above the range of viewing angle and between the driver DR and the window 12 or other suitable positions. The projection light source 280 may, for example, be a projection element capable of projecting light. In some embodiments, the transportation apparatus 3 may alternatively not include the eye tracking sensor 250 and/or the light-adjusting panel 130. Or, the transportation apparatus 3 may alternatively further include the voice-activated device 252.

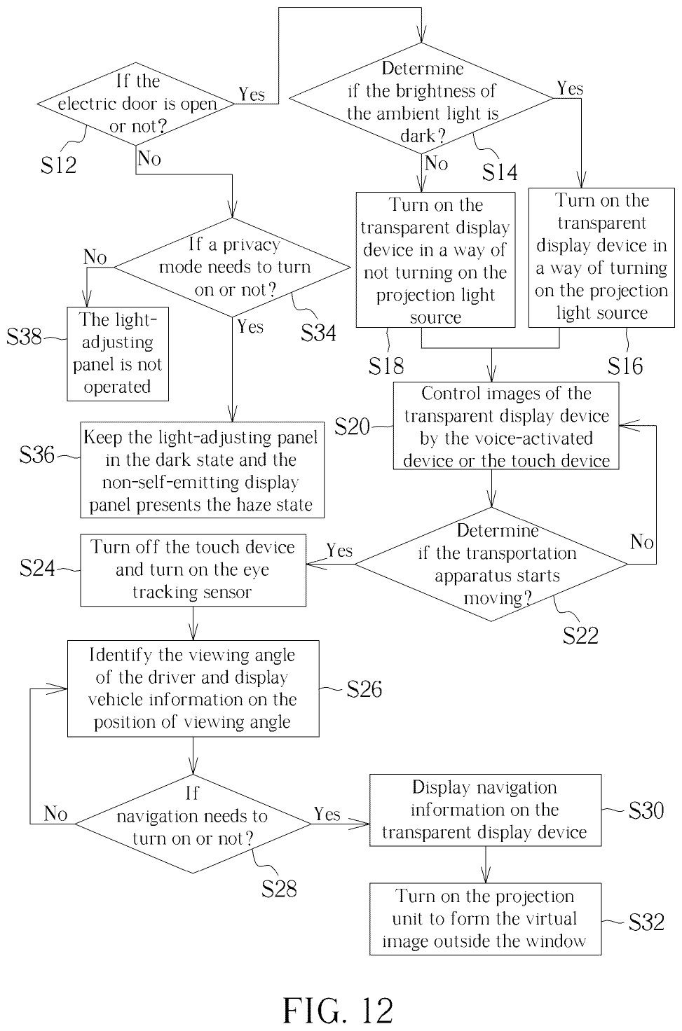

Refer to FIG. 12. FIG. 12 schematically illustrates a flow chart of an operating method of a transportation apparatus according to an embodiment of the present disclosure. As shown in FIG. 12, an operating method provided by this embodiment includes step S12 to step S38. The transportation apparatus of this embodiment may adopt any aforementioned embodiments. The transportation apparatus in the following contents takes the transportation apparatus 3 in FIG. 11 for example to describe the step S12 to step S38 in FIG. 12, and a car is taken as an example of the transportation apparatus 3, but not limited thereto.

As shown in FIG. 11 and FIG. 12, step S12 is performed to determine if an electric door (e.g., a car door) is open by the control unit in the transportation apparatus 3. When the control unit determines the electric door is open, step S14 is performed to detect the brightness of ambient light by, for example, the ambient light sensor and then to determine if the brightness of the ambient light is dark, for example, less than or equal to a predetermined brightness. When the control unit determines the brightness of the ambient light is dark, step S16 is performed to turn on the transparent display device 34 in a way of turning on the projection light source 280. Or, when the control unit determines the brightness of the ambient light is bright, which is the brightness of the ambient light is greater than the predetermined brightness, step S18 is performed to turn on the transparent display device 34 in a way of not turning on the projection light source 280. Afterwards, step S20 is performed to control the images of the transparent display device 34 by the voice-activated device or the touch device. For example, the control unit may be a control system in the transportation apparatus 3 to control all sorts of devices, but not limited thereto.

In the embodiment of FIG. 12, after step S20 is performed, step S22 is performed to determine if the transportation apparatus 3 starts moving by the control unit. In some embodiments, step S22 alternatively may be performed simultaneously with step S20 or may be performed before step S20, but not limited thereto. When the control unit determines the transportation apparatus 3 starts moving, step S24 may be performed to turn off the touch device and turn on the eye tracking sensor 250 to avoid affecting safety of the transportation apparatus 3 due to touching. Then, step S26 may be performed to identify the viewing angle of the driver DR by the eye tracking sensor 250 and control the transparent display device 34 to display vehicle information on the position of viewing angle. When the control unit determines the transportation apparatus 3 does not move, step S20 may continue to be performed.

In the embodiment of FIG. 12, after step S26 is performed, step S28 may optionally be performed to further choose if navigation needs to turn on. As navigation needs to turn on, step S30 is performed to allow the control unit of the transportation apparatus 3 to turn on navigation by the voice-activated device 252 and to display navigation information on the transparent display device 34. Afterwards, step S32 may be optionally performed to turn on the projection unit 18 to form the virtual image IM2 outside the window 12. For example, the viewing angle of the driver DR may be identified by the eye tracking sensor 250 to project the virtual image IM2 on the position of viewing angle of the driver DR. Besides, the contrast ratio of the virtual image IM2 may be dynamically adjusted by the light-adjusting panel 138 to enhance clarity of the virtual image IM2.

As shown in FIG. 12, after step S12 is performed, when the control unit determines the electric door is not open but the transportation apparatus 3 is unlocked, step S34 may be performed to ask a user if a privacy mode needs to turn on. In an embodiment, the privacy mode is the mode of the light-adjusting panel 120 in the dark state, such that the interior of the transportation apparatus 3 may not be easily seen from outside, but not limited thereto. The way of the user responding if the privacy mode needs to turn on may, for example, include pressing buttons or other suitable ways. When the privacy mode needs to turn on, step S36 is performed to keep the light-adjusting panel 120 in the dark state and the non-self-emitting display panel 260 presents the haze state. In some embodiments, when the transparent display device includes the scattering structure 14a in FIG. 1, the scattering structure 14a may present the haze state in step S36. When the privacy mode does not need to turn on, step S38 may be performed, such that the light-adjusting panel 120 is not operated.

In summary, in the transportation apparatus of the present disclosure, since the transparent display device may directly display images or present images by projection and does not display images on the window, the driver may not see the double image to enhance safety of the transportation apparatus and provide a better user experience. Furthermore, the augmented reality head-up display system may display the virtual image outside the window, so that the images of the transparent display device may be further combined with the virtual image according to requirements or may be further matched with the object or scenery to present augmented reality image with interactive information with the object. In addition, the eye tracking sensor and/or the voice-activated device may be interacted with the transparent display device and/or the augmented reality head-up display system in the transportation apparatus to display necessary information without affecting safety.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A transportation apparatus, comprising:
a window, wherein the window comprises a first region and a second region;
a transparent display device at least partially disposed on the first region;
a lens disposed on the second region; and
a projection unit disposed on a side of the window facing the lens,
wherein the projection unit projects a projection image onto the lens, and the first region and the second region are not overlapped with each other.

2. The transportation apparatus according to claim 1, wherein the transparent display device comprises a scattering structure.

3. The transportation apparatus according to claim 2, wherein a haze of the scattering structure is in a range of 5% to 15%.

4. The transportation apparatus according to claim 2, further comprising another projection unit disposed on a side of the scattering structure opposite to the window, and the another projection unit projects another projection image onto the scattering structure.

5. The transportation apparatus according to claim 2, further comprising a light-adjusting panel disposed between the scattering structure and the window.

6. The transportation apparatus according to claim 5, wherein the light-adjusting panel covers the first region.

7. The transportation apparatus according to claim 5, wherein the light-adjusting panel comprises two substrates disposed opposite to each other and a liquid crystal layer disposed between the substrates, the liquid crystal layer comprises a plurality of liquid crystal molecules and a plurality of dye molecules, and the plurality of dye molecules are mixed in the plurality of liquid crystal molecules.

8. The transportation apparatus according to claim 1, wherein the transparent display device comprises a plurality of self-emitting units.

9. The transportation apparatus according to claim 8, further comprising a light-adjusting panel disposed between the transparent display device and the window.

10. The transportation apparatus according to claim 8, further comprising a voice-activated device disposed on a side of the lens.

11. The transportation apparatus according to claim 8, wherein the transparent display device further comprises a first substrate, a second substrate disposed opposite to the first substrate, a circuit layer disposed between the first substrate and the second substrate, and the plurality of self-emitting units are disposed between the first substrate and the circuit layer.

12. The transportation apparatus according to claim 1, further comprising another light-adjusting panel, wherein the transparent display device is disposed between the window and the another light-adjusting panel.

13. The transportation apparatus according to claim 1, wherein the transparent display device comprises a non-self-emitting display panel and a front light source, and the front light source is disposed on a side of the non-self-emitting display panel opposite to the window.

14. The transportation apparatus according to claim 13, wherein the front light source comprises two light bars respectively disposed adjacent to two opposite edges of the non-self-emitting display panel.

15. The transportation apparatus according to claim 13, wherein the transparent display device further comprises a light guide plate and a protection layer, wherein the light guide plate is disposed on a surface of the non-self-emitting display panel opposite to the window, and the protection layer is disposed on a surface of the light guide plate away from the non-self-emitting display panel.

16. The transportation apparatus according to claim 1, further comprising a reflective mirror disposed on the side of the window facing the lens, wherein the projection image is projected onto the lens through the reflective mirror.

17. The transportation apparatus according to claim 16, further comprising another lens disposed between the projection unit and the reflective mirror.

18. The transportation apparatus according to claim 1, further comprising a spacer disposed between the lens and the window.

19. The transportation apparatus according to claim 18, wherein a thickness of the spacer is less than a focal distance of the lens.

20. The transportation apparatus according to claim 1, further comprising an eye tracking sensor disposed on a side of the transparent display device, wherein the eye tracking sensor is electrically connected to the transparent display device.
